(19) United States
(12) Patent Application Publication
(10) Pub. No.: US 2013/0085894 A1
(43) Pub. Date: Apr. 4, 2013

(54) SYSTEM AND METHOD FOR PRESENTING PRODUCT INFORMATION IN CONNECTION WITH E-COMMERCE ACTIVITY OF A USER

(71) Applicant: Jimmy Honlam CHAN, Fremont, CA (US)

(72) Inventors: Jimmy Honlam CHAN, Fremont, CA (US); Sam Mui, San Francisco, CA (US)

(21) Appl. No.: 13/251,120

(22) Filed: Sep. 30, 2011

(51) Int. Cl. G06Q 30/00

(52) U.S. Cl. 705/26.64; 705/26.62

(57) ABSTRACT

User activity is detected that indicates a user's interest in a product. The identifier of the product is determined and used to query a remote and independent network site to obtain information about the product of information. The information about the product of interest is then displayed to the user concurrently (e.g. as a mashup) with the page or resource that displays the product of interest

### TECHNICAL FIELD

Embodiments described herein include a system and method for presenting product information in connection with e-commerce activity of a user.

### BACKGROUND

It is common for online e-commerce sites to display information for products that are of interest to users, including manufacturer provided information and pictures and/or user-reviews and rankings. However, such information is hosted by the site and is thus restricted by limitations and bias that are inherent in the site being a retailer of the product of interest.

Products such as Intelligent Cross-Sell (“ICS”), provided by CNET, allow merchants to automate and optimize the targeting of cross-sells and upsells. The product can target based on a site's behavioral data (e.g. for example, recommending based on people who bought a product also bought another specific product) and/or a site's proprietary attributes, such as average user-review score or product profitability.

### BRIEF DESCRIPTION OF THE DRAWINGS

FIG. 1 illustrates a system for providing product information from a remote source in connection with a user's activity at an e-commerce site, according to an embodiment.

FIG. 2 illustrates a method for providing product information to a user in response to detecting a product of interest from a user's activity at an e-commerce site, according to an embodiment.

FIG. 3 illustrates a mashup of content that includes content from an e-commerce site and product information from a product information site, according to an embodiment.

FIG. 4 is a block diagram that illustrates a computer system upon which embodiments described herein may be implemented.

### DETAILED DESCRIPTION

Embodiments described herein include a system and method for presenting product information in connection with e-commerce activity of a user. In particular, embodiments described herein include a system and method for responding to user e-commerce activity at a particular network site, by enabling a client device to retrieve corresponding or relevant product information from a source that is remote to the network site.

According to embodiments, a client device is configured to operate independently of a site on which the e-commerce activity originates. In one embodiment, the client device is triggered by data contained in the webpage or resource provided from an e-commerce site, to retrieve relevant product information from an independent information source. More specifically, the client device is configured to initiate the retrieval in response to, for example, the coding contained in a URL and/or the text that appears on a web page.

In some embodiments, the client may be provided by way of a plug-in for a web browser or other web-application.

According to embodiments, a browser or other client of the user terminal can be configured to be triggerable by certain types of information or data provided from an e-commerce site (or alternatively, any e-commerce site). The browser or client can be triggered into in retrieving and presenting product information from a remote source of related product information. Additionally, the remote source may be independent of (or independently operated from) the e-commerce site that triggered the browser or client to perform the retrieval.

The data that triggers the client to perform the retrieval may be agnostic as to the presence of the client functionality. Specific examples of activity that can carry data to trigger the retrieval activity include, for example, (i) browsing activity by the user at a particular e-commerce site, where the activity specifies by text or code (e.g. product code) a particular product, (ii) a user selecting a particular product for additional information, such as by viewing pictures are customer reviews of the product, (iii) the user queuing the product in a shopping cart, or otherwise initiating selection of the product for purchase, and/or (iv) the user providing final input to make purchase of the product (e.g. the user checking out after placing item in shopping cart).

In connection with a user's activity at a particular site, some embodiments provide for retrieving and presenting product information to the user from a remote and independent source. Additionally, some embodiments provide for presenting the retrieved product information concurrently with content generated from the e-commerce site. In one implementation, a mashup is generated to concurrently display the product information from the remote source along with content from the e-commerce site. The mashup can be generated in response to the user's activity at the e-commerce site (e.g. user selecting a product for purchase by placing it in a shopping cart). For example, product information from the remote source may be displayed to the user as an overlay, flyover or under, pop-up, or dynamically generated window or display area adjacent to content provided from the e-commerce site.

Some embodiments provide for various types of product information to be presented to the user concurrently with the performance of certain triggering e-commerce activities. For example, a user may select a merchandise item for purchase by placing a virtual representation of the item in a shopping cart. With such functionality, the selection mechanism can further extend to when the user “checks out” by selecting to purchase (or initiate the process to purchase) the items listed in the shopping cart. According to embodiments, prior to the user completing the transaction, a window is concurrently displayed to the user that displays product information relevant to the user's purchase. In particular, embodiments may utilize an identifier or characteristic of the merchandise items selected by the user as a criteria for searching for relevant product information that is then displayed to the user in some fashion.

Some embodiments described herein may be implemented in the context of a user operating a computer and executing an application such as a browser (or alternatively a web-app). Specific examples of online sources for commercial transactions include online merchant sites (e.g. www.amazon.com), auction sites (e.g. www.ebay.com), online retailers, and online classified advertisements (e.g. www.craigslist.com). Still further, numerous such sites include web-applications that provide the functionality of the corresponding website to the user through execution of a substantially dedicated application. Still further, some embodiments include programmatic components for accessing a remote source for product information that is relevant to merchandise items of interest to the user. Such remote source of product information can be provided at, for example, product informational review sites (e.g. www.cnet.com).

At least some embodiments include programmatic components or resources that execute in an online environment. In particular, the programmatic components or resources may reside or execute with a user's browser or client. The programmatic components may alternatively reside or execute with a server that serves requests to the browser/client. In one embodiment, programmatic components or resources that implement functionality of embodiments described herein are provided as a plug-in to a client-side browser or web application.

In one embodiment, online activity of a user is monitored to detect a user's selection or interest in a merchandise item. The product identifier of the product is determined and used to query a remote and independent network site to obtain information about the product of information. The information about the product of interest is then displayed to the user concurrently (e.g. as a mashup) with the page or resource that displays the product of interest.

According to an embodiment, a determination is made that a user is interested in a product. The determination may be based on a user's activity in connection with a first network site. Embodiments further provide for identifying the product of interest, and then using an identifier of that product to generate a query that is communicated to a second network site, from which product information is retrieved and presented. In this way, the query results in the generation of product information that is about, or otherwise relevant to the product that is of interest to the user.

Still further, in some embodiments, a presentation is generated that concurrently displays (i) a content generated from an e-commerce site pertaining to the product of interest, and (ii) content that includes product information originating from a second site (remote to the e-commerce site), that is relevant to the product of interest. The presentation may be triggered in response to a particular user activity, such as user selection of a merchandise item for purchase (e.g., placement of merchandise item in shopping queue or ‘check out’ therefrom). Furthermore, embodiments provide that product information is based on a product identifier and/or characteristic of the selected product.

Among other benefits, embodiments enable users to operate client terminals in connection with e-commerce activities, in order to retrieve relevant product information from sites or sources that are independent of the e-commerce source. In this way, the user has the ability to procure additional information from an information source that has less bias, and/or provide alternative information/opinion for a product that the user is considering purchasing. Furthermore, the information can be provided to the user automatically, in a mashup that preserves the content from the e-commerce site, so as to not interrupt or disturb the user's e-commerce activity.

One or more embodiments described herein provide that methods, techniques and actions performed by a computing device are performed programmatically, or as a computer-implemented method. Programmatically, as used herein, means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

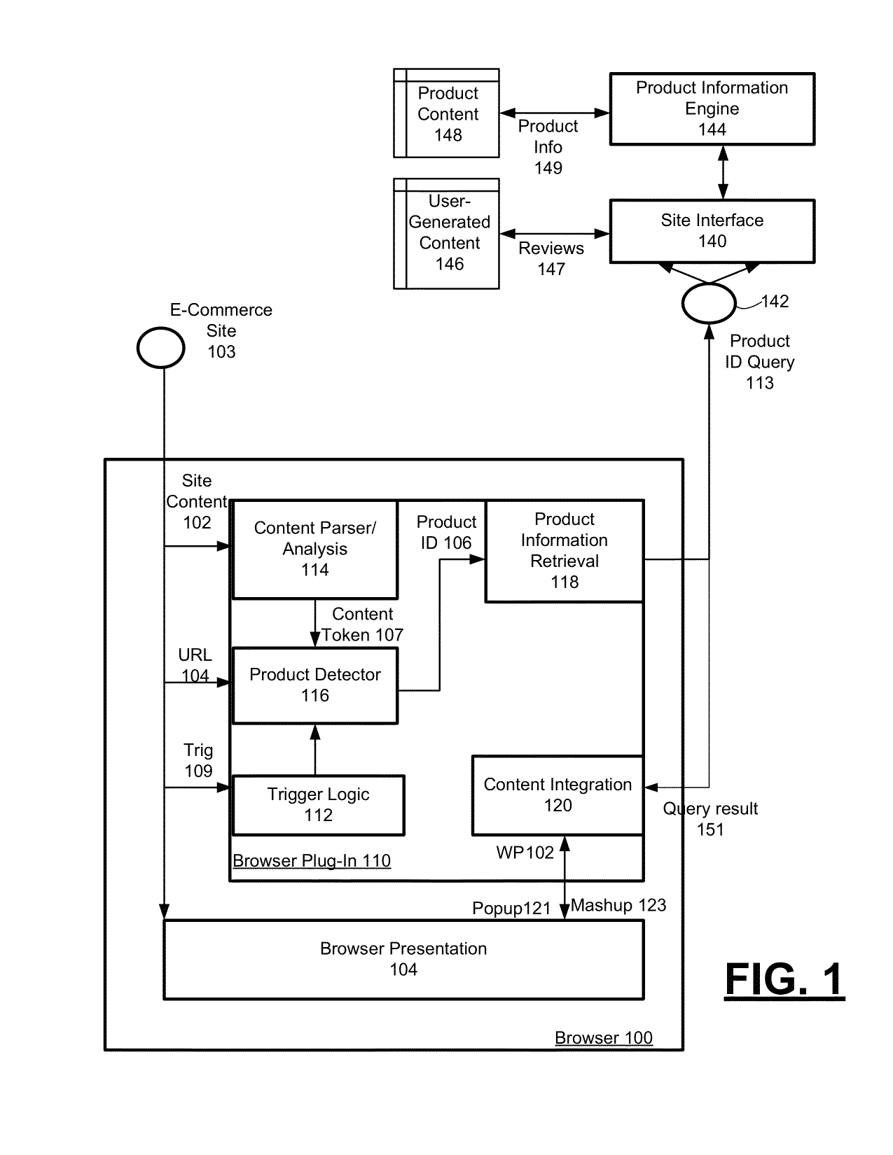

FIG. 1 illustrates a system for presenting product information to users in connection with e-commerce transactions and activities, according to embodiments. A system such as described by FIG. 1 may be implemented on a user-computing environment, such as through a web browser executing on a user computing device (e.g., desktop machine, laptop, tablet, mobile computing device etc.), a web-based application, or plug-in for a browser or other application. Accordingly, some embodiments provide that a system 100 may be implemented through functional elements that execute within an application, such as by way of a plug-in or programming resource that executes within a browser or web application of a user device.

In an embodiment of FIG. 1, system 100 is implemented as a plug-in 110 within a commercially available browser 100 (e.g. MOZILLA). The plug-in 110 (or programming resource) may be downloaded from, for example, a site that is independent of the e-commerce site(s) where the user performs e-commerce activity to receive the functionality of the plug-in. According to at least some embodiments, the plug-in 110 may include functionality corresponding to a trigger logic 112, content analysis 114, product detector 116, product information retrieval 118, and content integration 120. In operation, browser 100 executes to download webpages 102 from websites where products are offered for sale. Typically, an e-commerce site offers merchandise items, along with local content that includes product information, such as manufacturer provided product information and customer reviews (from customers of the site who previously purchased the product). The manufacturer supplied information can include pictures, specifications (dimensions, weight, material, technical specifications) and other content. The customer reviews may include ratings. Additionally, some sites offer recommendations to other products based on, for example, a knowledge as to what other products viewers of one item have previously been interested in.

In one embodiment, trigger logic 112 processes a designated data input 105 in order to respond to a triggering event or condition in which a product is deemed to be of interest to the user. The designated data input 105 may correspond to, for example, the URL for a web page, metadata associated with or provided from a web page that is downloaded, and/or other data provided from a webpage (e.g. key words). Still further, the data input 105 is processed to detect a triggering condition detected by the trigger logic 112. In one embodiment, the condition detected by the trigger logic 112 corresponds to the browser accessing the URL 104 of (i) a particular domain, such as a domain associated with a merchandise or commercial forum, and (ii) the presence of a product code, term or name in the URL. In variations, the triggering condition may correspond to other domain markers in the URL 104, the presence of a particular code or term in metadata associated with or provided from a web page, or the presence of a keyword or other term provided in the content of a web page. As an addition or alternative, the triggering logic may respond to user-input to perform the product comparison automatically in response to a user selection input (e.g. user selects icon appearing on screen). Still further, the triggering condition may be satisfied by presence of multiple conditions, such as the combination of the product identifier being present in the URL of a particular domain.

When the triggering condition is satisfied, the trigger logic 112 triggers product detector 116, resulting in the product detector 116 processing information provided in connection with the downloaded web page. The product detector 116 processes the information to determine an identifier for a product that is rendered with the web page. The product detector 116 processes information corresponding to one or more of (i) the characters that comprise the URL, (ii) the text or content (e.g. images) included in the webpage, and/or (iii) metadata associated with the webpage. Embodiments further recognize that certain e-commerce sites associate product identifiers in the URL that is used to select the product for additional viewing and/or purchase (e.g. addition of product item to shopping cart and/or selection of products for checkout). For example, the URLs can include a product code that maps to a specific product identifier (e.g. manufacturer and/or model of product type of class), product type or class (e.g. high-definition television), or other markers (e.g. manufacturer). The product detector 116 may map the product identifier included in the URL to a product identifier used by the remote source. As an alternative or variation, the product identifier may correspond to a keyword (e.g. brand name, or trade name) or product identifier that can be recognized and processed by the remote source.

In response to the triggering condition, an embodiment provides that product detector 106 includes logic to determine, from the web page data, a product identifier 106. The product information retrieval 118 uses the product identifier 106 to signal the remote source, in order to retrieve relevant product information. In one implementation, the product identifier 106 is identified from a product-specific alphanumeric string that is integrated into the URL. For example, an embodiment recognizes that websites such as those hosted via the domain of AMAZON typically included a product product-specific alphanumeric string in the URL when the user selects to view a product or adds the product to its shopping cart. The string may be used as a product identifier in order to retrieve supplemental content.

As an alternative or addition, the content provided on, for example, the web page or portion thereof may be analyzed for text and/or metadata in order to identify product identifiers. In one implementation, content analysis 114 includes logic that locates or identifies identifiers (e.g. text, alphanumeric character strings) or markers (e.g. brand or trade name, key words) for a product from content provided on a webpage. Accordingly, in response to a triggering condition, the content analyzer tokenizes, or otherwise parses the content 102 from the webpage of the site 103 to enable detection of product identifiers or markers. In one implementation, the content analysis 114 scans the relevant text of the webpage, including characters or coding that can either identify the product, or serve to locate an identifier of the product on the webpage. As an example, the content analysis 114 may execute to identify the presence of a designated character set such as “Model Number”, “SKU”, or “ASIN”. The designated character set may be specific to a domain or site, and can serve as a marker for a product identifier (e.g. typically adjacent to the character code). In one implementation, the content an content analysis 114 generates tokenized content 107 for product detector 116. Content analysis 114 and product detector 116 can execute to identify markers that are indicative of the product name or identifier (e.g. manufacturer and model number). The product name or descriptor may be characterized by, for example, markers such as the largest font text appearing centrally at the top of the product information portion of the webpage, or text that appears in the title portion of an online classified advertisement. The product detector 116 may also execute to identify product markers such as “SKU” or “ASIN” or “model number”. Such product markers can be programmatically identified from the text content of a webpage, from metadata provided with a webpage, or from characters included or associated with a URL.

Accordingly, embodiments provide that the product detector 116 executes to extract, from the webpage, the product identifier(s) 106 from sources that include one or more of (i) URL, (ii) content provided on a webpage (e.g. text content), and/or (iii) metadata provided with the web page. The product identifiers 106 can be in the form of text or characters which identifies a manufacturer, model number and/or product class (e.g. “3-D television” or “high performance laptop”). Alternatively, the product identifiers can be in the form of a code that can map to a product identifier (e.g. domain specific code). Additionally, the product identifier can include identifiers such as SKU, ASIN, or model number. The product identifiers 106 are supplied to the product information retrieval component 118.

In one embodiment, the product information retrieval 118 includes logic to communicate with a remote source. The remote source can correspond to a third party service that provides enhanced product information and user generated content for products, including products that correspond to the category or kind that are displayed on the webpage 102. In one embodiment, the product information retrieval component 118 is configured to communicate with a service site 140, using, for example, an application program interface 142 provided by the service site.

In one embodiment, product information retrieval component 118 generates a product query 113 which specifies at least one of the product identifiers 106. In one implementation, query 113 is handled by the service site interface 140. The service site interface 140 may communicate with the product information engine 144 in order to obtain additional product information about the particular product. For example, site interface 140 may access user generated content 146, such as expert reviews that specify information about the product identified by the product query 113. The product information engine 144 may further access product content 148 in order to generate enhanced product information 149. The site interface 140 is configured to compile the user generated content 147 and the product information 149 into a query result 151 that is communicated back to the plug-in 110.

In one implementation, query result 151 is handled by content integration 120, which includes operations to filter, sort, format or arrange content provided in the query result 151. In particular, content integration 120 is configured to format the content to supplement existing content rendered through a browser presentation component 104. For example, one implementation provides that the content integration 120 generates a pop-up 121 that displays the product information provided to the query result 151 as an independent panel or window to that of the existing content of the webpage 102. In another implementation, content integration 120 is configured to generate a mashup 123 that displays the product information from the query result 151 in some integrated fashion with the existing content of the webpage 102. The mash up pop-up 123 may generated from the content integration component 120 utilizing portions of the webpage content rendered to the browser's presentation 104. For example, a checkout box for a product the user has selected to purchase may include a flyover window that displays product information from the query result 151. The pop-up 121 and/or mash up 123 may be integrated into the browser presentation 104, so that the user is able to view content from multiple sources when considering a product purchase.

Various kinds of product information may be extracted and presented from the courier result 151. In one embodiment, the site service 140 corresponds to a highly knowledgeable site where products are reviewed by experts, described by manufacturer or expert, subjected to user reviews and feedback, rated, provided comparative shopping (or pricing) results, and associated with governmental information such as recalls, energy conservation rankings or safety recalls. The content integration component 120 may use any of the kinds of information provided in the query result 151 to supplement the webpage content 102 where the product is presented.

In one embodiment, the browser plug-in 110 executes the trigger component 112 to detect a triggering condition, from which processes for product detection (e.g. content parsing, URL analysis) takes place. In one implementation, the trigger 112 detects a triggering condition corresponding to the user selecting an item for purchase. For example, on an e-commerce site, a user can typically perform several types of activities, including searching for merchandise items, viewing or researching merchandise items, and selecting merchandise items for a shopping cart or purchase. At some point, the user may select to purchase the product by clicking on a feature where the item is added to some form of a queue, such as a shopping cart. The trigger logic 112 may operate to identify triggering conditions that correspond to, for example, webpages of a particular domain, a product page, a shopping cart and/or a purchasing page.

In response to detecting such a page, the product detector 116 parses the URL and/or text content on the web page to determine a product identifier, such as a product name, product class, or other product identifier (e.g. SKU, model number and manufacturer). The product identifier may then be used to search and retrieve supplemental content about or relevant to the product (e.g. expert reviews, independent reports about the product), information about other products of the same class, information about the manufacturer, product comparison information, or governmental information (e.g. safety recalls, environmental information). The supplemental content can be provided at the same time as the content from the e-commerce site, giving the user a chance to affirm or reconsider his purchase by viewing information from the remote site.

As example, the input trigger 109 may be generated in response to the user viewing a product page on an e-commerce site, reviewing user comments about a product, or selecting a particular category of products. Still further, in other variations, the triggering logic 112 may respond to input in the form of a triggering condition that corresponds to the user navigating to any predetermined e-commerce site where products can potentially be purchased.

As still another variation, the triggering component 112 may be responsive to user input. For example, a user may select to execute the processes provided by the browser plug-in 110 when for example, the user is viewing any given webpage containing a product. For example the user may scan online classifieds for used products, identify product on a particular classified ad, and provide the input via the triggering component 112 to initiate the processes described for the browser plug-in 110.

Methodology

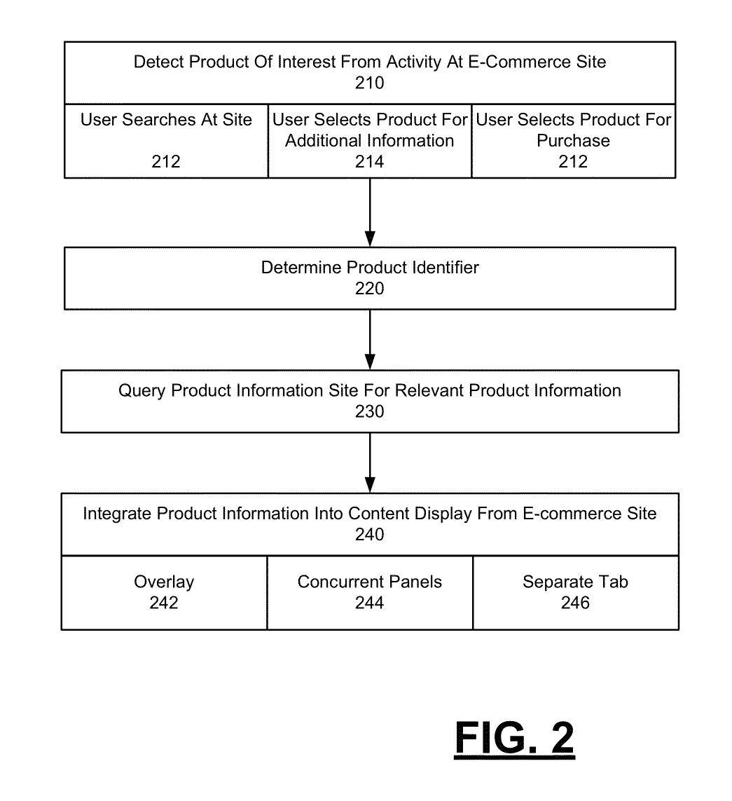

FIG. 2 illustrates a computer-implemented method for presenting product information to facilitate online transactions, according to embodiments. A method such as described by an embodiment of FIG. 2 may be implemented using, for example, components described with an embodiment of FIG. 1. Accordingly, reference is made to elements of FIG. 1 for purpose of illustrating a suitable element or component for performing a step or sub-step being described. A method such as described with an embodiment of FIG. 2 may be performed on, for example, a user terminal (e.g. operating a browser or application). In some embodiments, functionality such as described below may be provided through a programmatic resource (e.g., browser plug-in) that executes on the user terminal, and which originates from a source that is independent of the e-commerce site where the relevant e-commerce activity takes place (e.g., where triggering event takes place).

In an embodiment, a product of interest is detected from the user's activity at an e-commerce site (210). The detection process may be performed by software or logic executing a computing device, during, for example, users web browsing session. The detection process may detect user activity that corresponds to, for example, one or more of the following: (i) the user searching for a particular product at a site (212); (ii) the user performing an action such as specifying selection input for a product in order to receive additional information about that product (214); or (iii) the user selecting a product for purchase (216). These and other product detection activities may be further performed in response to triggering events. The triggering event may correspond to the user performing a corresponding activity (e.g. searching, selecting, attempting to purchase) or providing triggering input to initiate the product detection process.

Once the product of interest is detected, one or more identifiers for the product of interest are determined (220). Various techniques may be used to determine the product identifier from the webpage data. In one implementation, the product identifiers are determined from analyzing the characters embedded in the URL of a webpage (222). The URL of a product page, purchasing page, or shopping site can be scanned or parsed for codes that are identifiers of products.

In another implementation, the product identifiers are identified from analyzing content (224), such as text content (e.g. expert reviews, user-generated content, etc.). In one implementation, the text analysis includes scraping the content, which can be analyzed for placement, prominence, keyword matching, and/or various other characteristics. Furthermore, such text analysis can serve to determine the subject of the content (e.g. product that is displayed on the merchandise webpage). In addition to keyword identification (which can match to product, product type, classifications etc.), the text analysis can be used to identify numeric or character coded identifies for product. Such character identifiers include, for example, the SKU, ASIN and/or item model number.

According to some embodiments, the plug-in (or system performing the steps described) queries a remote or external site where enhance product information is accessible. In one implementation, the remote or external site is operated independently of the website where the product information is provided. In variations, however, the remote or external site include functional components that can form part of the system for providing the additional and enhance product information. In one embodiment, the external site includes an API for responding to queries that specify product identifiers. The query that is generated may specify one or more of the product identifiers (230). The query may be structured or formatted to accommodate the remote site. The formatting may include specifying product identifiers in a predetermined format in use by the remote site. In addition, the product identifier may be altered or converted with logic to specify an alternative meaningful product identifier for the remote site. For example, if the product identifier detected on a particular page is for a specific model and manufacturer of a product, the query may specify a product class as an alternative or addition to the model number and manufacturer.

The query to the remote or external site generates a query result, from which information and content can be extracted and displayed (24). The query result may be generated in connection with content from the website that generates the webpage of the merchandise object (240). In one embodiment, the query results includes text and or image content that includes information such as expert reviews, manufacturer supplied information, reseller provided information, user reviews and feedback, rankings from users and/or experts, comparative shopping (or pricing) analysis and results, and/or governmental information such as energy conservation information or safety recalls.

The information of the query result can be selected (based on user preference are predetermined priority scheme) and/or formatted (resized, font changed, picture deletion etc.), then presented in connection with the webpage on which the merchandise object is provided. Various presentation formats can be utilized and presenting the information from the quarry result in connection with the webpage of the merchandise object. A supplemental presentation may be generated in the form of an overlay (242), one or more concurrent panels (244), and/or one or more separate tabs (246).

In one implementation, the supplemental content is integrated in the form of a mashup with the webpage content. In this form of supplemental content is presented to in a manner that is highly integrated and concurrent (e.g. overlay) with the content of the webpage. Furthermore, the supplemental content itself may carry content from the webpage. For example a flyover or overlay may include extracted portions of the content from the webpage, such as image of the product as provided on the webpage, as well content from the remote source.

In displaying the content from the remote source, the content may be formatted and edited programmatically, on-the-fly, for display in a concurrent form (e.g. in a mashup). For example, the query to the remote source may generate content that can be resized, stripped of advertisement and images or extraneous information, re-sized, and edited (e.g. portions of the content selected over other portions). The result is that the content from the remote source can be displayed in a relatively small panel or portion of a webpage, so as to be supplemental to the content that is existing from the e-commerce site.

Presentation

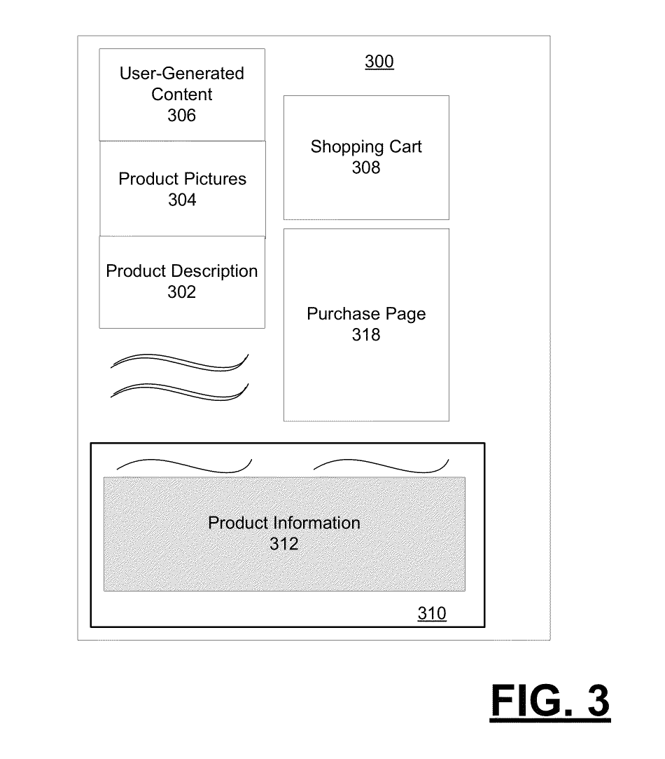

FIG. 3 illustrates a presentation that can be generated in accordance with one or more embodiments. According to some embodiments, a presentation 300 may be generated to include content from separate or disparate sources regarding merchandise object on a source webpage. In one embodiment, a webpage 300 is rendered onto the user's browser or web-based application, in response to a user navigating to for example, an e-commerce site. The webpage 300 may include product information or description 302, pictures 304, and/or user-generated content 306. The user-generated content 306 can include, for example, feedback from users who purchase the product and submitted comments about the product through the site that hosts the webpage.

Additionally, the presentation 300 may include commerce functionality for enabling the user to initiate a transaction to purchase the product. Specific examples of commerce functionality include a shopping cart 308, which lists items the user has selected for purchase. Shopping carts 308 often include functionality to enable the user to add or remove products, as well as to increase the quantity of the items being purchased. In addition to the shopping cart 308, the commerce functionality includes a purchasing page 318, which can be presented as a page that lists the product and purchase price (including tax and shipping), along with an interface that enables the user to enter a confirmation input to complete the transaction for purchase of the item.

In one embodiment, supplemental content 310 is generated to include product information 312 that originates from a remote source that is independent of the website that hosts the webpage 300. For example, the remote source may include a service accessible from a website where enhanced product information is provided (e.g. CNET). Such a remote source may supply the product information 312 of the supplemental content 310. Furthermore, the remote source may be operated independently of the e-commerce site. For example, the response from the e-commerce site may be transmitted without awareness of the functionality executing on the user terminal.

As an alternative or variation, multiple remote or external sites may be used to aggregate and present product information in a supplemental form.

The product information may include, for example, expert reviews, manufacturer supplied information, reseller provided information, user reviews and feedback, rankings from users and/or experts, comparative shopping (or pricing) analysis and results, and/or governmental information such as energy conservation information or safety recalls. As a specific example, the product reviews may be conducted by an expert, who ranks the product (e.g. scale of one through five) and further highlights the positive and negative aspects of the product (e.g. “The Good”, “The Bad” and “The Ugly”).

In one embodiment, the product information 312 is displayed in the form of an overlay, which can be at least partially transparent. In variations, the product information 312 can be provided as a flyover, separate tab, or other dynamic, so that the product information of the supplemental content is display concurrently with the webpage and its product information. Such a display may alternatively be referred to as a matchup.

Computer System

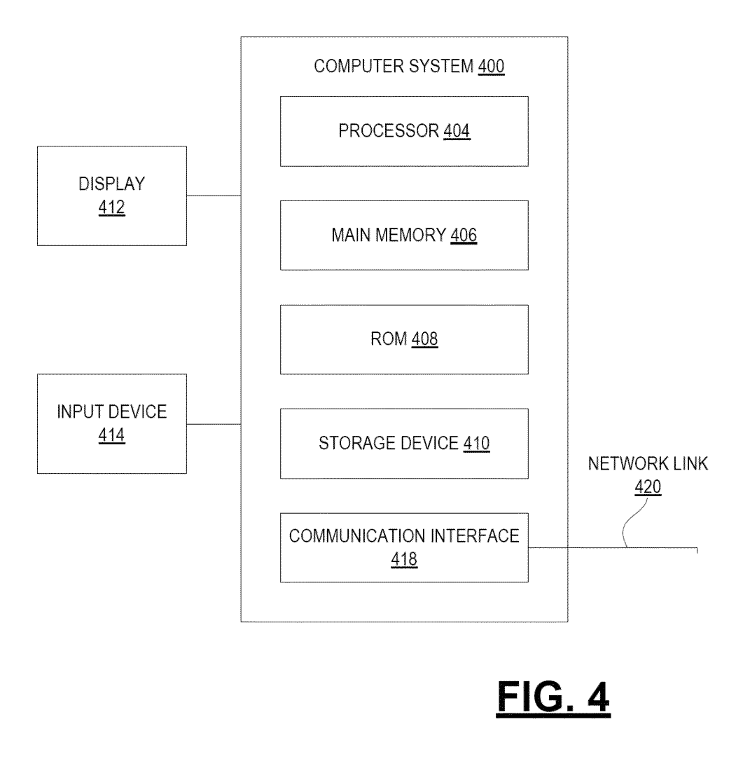

FIG. 4 is a block diagram that illustrates a computer system upon which embodiments described herein may be implemented. For example, in the context of FIG. 1, system 100 may be implemented using a computer system such as described by FIG. 4.

In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) 408 or other static storage device for storing static information and instructions for processor 404. A storage device 410, such as a magnetic disk or optical disk, is provided for storing information and instructions. The communication interface 418 may enable the computer system 400 to communicate with one or more networks through use of the network link 420.

Computer system 400 can include display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments may include any number of input devices 414 coupled to computer system 400.

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-implemented method for presenting product information in an online environment, the method being implemented by one or more processors and comprising:
(a) detecting a triggering condition based oFIG. 4 illustrates a computing system on which one or more embodiments may be implementedn a user activity at a first network site;
(b) determining an identifier of a product that is deemed of interest in response to the triggering condition;
(c) generating a query that is based on the identifier, the query being communicated to a source that is remote to the first network site, the remote source including an information library that includes information about a plurality of products;
(d) generating a presentation that concurrently displays (i) a content generated from the first network site pertaining to the product of interest, and (ii) product information relevant to the product of interest that is retrieved from the remote source using the generated query.

2. The method of claim 1, wherein (a) includes detecting that a user is viewing a web page hosted at an e-commerce site that is specific to the product of interest.

3. The method of claim 1, wherein (a) includes detecting that a user has selected a product for placement in a queue for purchase.

4. The method of claim 1, wherein (a) includes detecting a product that a user searches for a product at a webpage or online resource.

5. The method of claim 1, wherein (b) includes determining a product name and/or manufacturer for the product of interest.

6. The method of claim 1, wherein (b) includes determining an alphanumeric identifier for the product of interest.

7. The method of claim 1, wherein the remote source corresponds to a service provided by a second network site that is operated independently of the first network site.

8. The method of claim 1, wherein the service provides product information corresponding to user and/or expert reviews that are relevant to the product of interest.

9. The method of claim 1, wherein the product information includes (i) identification of other products that are of a same category; and/or (ii) comparison information between the product that the user is interested in and one or more other products that are of the same category.

10. The method of claim 1, wherein the product information includes information that identifies whether the product has been recalled.

11. The method of claim 1, The method of claim 1, wherein the product information includes information that identifies a release date of the product.

12. The method of claim 1, wherein steps (a)-(d) are performed by a browser of a terminal of the user.

13. The method of claim 1, wherein steps (b)-(c) are performed automatically in response to performing step (a).

14. The method of claim 1, wherein steps (b)-(c) are performed in response to user input.

15. The method of claim 1, wherein step (d) includes generating a flyover or overlay on a webpage that is hosted by the first network site.

16. The method of claim 1, wherein (b) includes determining a product name or manufacturer for the product that the user is interested in.

17. The method of claim 1, wherein (b) includes determining an alphanumeric identifier for the product that the user is interested in.

18. A computer readable medium that stores instructions for presenting product information for an online environment, the instructions including instructions that, when executed by one or more processors, cause the one or more processors to perform operations that comprise:
(a) detecting a triggering condition based on a user activity at a first network site;
(b) determining an identifier of a product that is deemed of interest in response to the triggering condition;
(c) generating a query that is based on the identifier, the query being communicated to a source that is remote to the first network site, the remote source including an information library that includes information about a plurality of products;
(d) generating a presentation that concurrently displays (i) a content generated from the first network site pertaining to the product of interest, and (ii) product information relevant to the product of interest that is retrieved from the remote source using the generated query.

19. The computer-readable medium, wherein the instructions are formatted to be executed as a plug-in for a browser.

20. A system for presenting product information, the system comprising:
a browser plug-in, executable on a terminal of a user, detect a triggering condition based on a user activity at a first network site;
determine an identifier of a product that is deemed of interest in response to the triggering condition;
generate a query that is based on the identifier;
generate a presentation that concurrently displays (i) a content generated from the first network site pertaining to the product of interest, and (ii) product information relevant to the product of interest that is retrieved from the remote source using the generated query; and
a service that provides access to a product information library, the service being provided remotely and independent of the first network site, wherein the service includes an interface to receive and handle the query generated from the terminal and to respond with information that includes the product information.
